(19) United States
(12) Patent Application Publication
(10) Pub. No.: US 2024/0248164 A1
(43) Pub. Date: Jul. 25, 2024

(54) DETERMINING LOCATIONS OF MOBILE DEVICES FROM WIRELESS SIGNALS

(71) Applicant: Sonitor Technologies AS, Oslo (NO)

(72) Inventors: Wilfred Edwin BOOIJ, Oslo (NO); Hans Magnus EWALD, Oslo (NO)

(73) Assignee: Sonitor Technologies AS, Oslo (NO)

(21) Appl. No.: 18/289,423

(22) PCT Filed: May 6, 2022
(86) PCT No.: PCT/GB2022/051162

§ 371 Date: Nov. 3, 2023

(30) Foreign Application Priority Data
May 7, 2021 (GB) 2106546.1
Oct. 22, 2021 (GB) 2115190.7

(51) Int. Cl. G01S 5/14; H04W 64/00

(52) U.S. Cl. CPC G01S 5/14; H04W 64/00

(57) ABSTRACT

A method of determining a respective location of each of a set of one or more mobile devices (3) of a network of devices (3, 4). The method includes receiving data comprising a set of values representative of distances between respective pairs of devices (3, 4) of the network of devices (3, 4), wherein the values representative of distances are determined from wireless signals transmitted f between the devices (3, 4). The values representative of distances are processed to determine a set of coefficients for a system of linear equations, and the system of linear equations is solved to determine two-dimensional or three-dimensional coordinates representative of the location of each of the set of one or more mobile devices (3) in a two-dimensional plane or a three-dimensional space.

### BACKGROUND OF THE INVENTION

This invention relates to methods, software and apparatus for determining locations of mobile devices of a network of devices.

It is known to determine the locations of mobile devices, such as RFID tags or cell phones, of a network of devices (which may also include one or more static devices), by transmitting acoustic or radio signals between the devices in order to estimate the distances between pairs of the devices. Locations may be estimated using techniques such as trilateration or pattern-matching. However, it is not straightforward to do so efficiently and reliably.

The present invention seeks to provide a novel approach for determining the locations of mobile devices efficiently and reliably.

### SUMMARY OF THE INVENTION

From a first aspect, the invention provides a method of determining a respective location of each of a set of one or more mobile devices of a network of devices, the method comprising:
receiving data comprising a set of values representative of distances between respective pairs of devices of the network of devices, determined from wireless signals transmitted between the devices;
processing the values representative of distances to determine a set of coefficients for a system of linear equations; and
solving the system of linear equations to determine two-dimensional or three-dimensional coordinates representative of the location of each of the set of one or more mobile devices in a two-dimensional plane or a three-dimensional space.

From a second aspect, the invention provides computer software for determining a respective location of each of a set of one or more mobile devices of a network of devices, wherein the computer software comprises instructions which, when executed by a processing system, causes the processing system to:
receive data comprising a set of values representative of distances between respective pairs of devices of the network of devices, determined from wireless signals transmitted between the devices;
process the values representative of distances to determine a set of coefficients for a system of linear equations; and
solve the system of linear equations to determine two-dimensional or three-dimensional coordinates representative of the location of each of the set of one or more mobile devices in a two-dimensional plane or a three-dimensional space.

From a third aspect, the invention provides a location system comprising a processing system and a memory, wherein the memory stores software comprising instructions which, when executed by the processing system, cause the processing system to:
receive data comprising a set of values representative of distances between respective pairs of devices of the network, determined from wireless signals transmitted between the devices;
process the values representative of distances to determine a set of coefficients for a system of linear equations; and
solve the system of linear equations to determine two-dimensional or three-dimensional coordinates representative of the location of each of a set of one or more mobile devices in a two-dimensional plane or a three-dimensional space.

The processing system may, in some embodiments, further comprise the network of devices, which may include one of more static devices in addition to the one or more mobile devices.

Thus it will be seen that, in accordance with embodiments of the invention, two-dimensional (2D) or three-dimensional (3D) coordinates can be determined for one or more mobile devices by solving a linear system. This approach is based on the insight that the locations of the one or more devices, considered as coordinates in the plane or in a three-dimensional space, can be represented by a consistent set of linear combinations of the locations of the other devices in the network, leading to a linear relationship between the device locations. This linearity enables a linear system to be solved to determine the locations of individual or multiple devices efficiently and consistently. It can also advantageously enable the locations of mobile devices to be determined accurately even for devices that are in effective wireless range only of other devices that are also of unknown location—i.e. even when there is no direct distance measurement available from the mobile device to a device of fixed or known location, such as to a static beacon or a mobile device of known position.

It will be appreciated that, in some embodiments, the coordinates may be two-dimensional coordinates (e.g. x, y) representative of a respective location of each of the one or more mobile devices in a two-dimensional plane (e.g. corresponding to a plan view of an environment). However, in some embodiments, the coordinates may be three-dimensional coordinates (e.g. x, y, z) representative of respective locations of the one or more mobile devices in three-dimensional space (e.g. including height information).

In some embodiments, the wireless signals may be radio signals, such as Bluetooth Low Energy™, WiFi™ or NFC signals. In some embodiments, the wireless signals may be acoustic signals, such as ultrasound signals. A combination of radio and acoustic signals may be used to determine the data representative of distances. In some embodiments, one or more of the mobile devices may be a smartphone or an electronic tag configured to send and receive wireless signals. The network of devices may be arranged to communicate as a radio mesh network.

In some embodiments, data representative of distances between pairs of devices of the network may be determined based on a signal strength measure of the wireless signals transmitted between the devices. The data may be determined based on one or more of received signal strength indicators (RSSI) of the wireless signals, angle of arrival (AoA) measurements, round trip time (RTT) measurements, time of arrival (ToA) measurements, or time difference of arrival (TDoA) measurements.

RSSI, AoA, RTT, ToA and/or TDoA measurements may be processed in any appropriate way (e.g. by filtering, averaging or otherwise) as part of determining the data representative of distances, e.g. in order to improve the accuracy or quality of the location determination process.

The processing system may comprise a networked server, which may be distinct from said devices of the network (i.e. the devices whose locations are involved in the system of linear equations). However, in other embodiments, the processing system may comprise a processor of one or more of the devices—e.g. one of the mobile devices.

In some embodiments, the location system (i.e. positioning system) may comprise one or more of the devices. It may comprise all of said devices of the network. (It will be appreciated, however, that these devices may in some embodiments be part of a larger network, comprising other devices that are not included in the system of linear equations—e.g. devices for which no distance data, or insufficient distance data, is received.) It may be a real-time location system (RTLS).

The processing system may receive the distance data, e.g. from one or more of the devices of the network, or it may be configured to generate some or all of the distance data, e.g. by processing measurement data, such as RSSI values, received from one or more of the devices of the network. Receiving the data may comprise accessing the data within the processing system, e.g. reading the data from a memory of the processing system.

The values representative of distances between pairs of devices may be noisy or approximate data. Processing the values to determine the coefficients may comprise scaling the values based on a level of noise in the set of values.

The system of linear equations may be determined, at least in part, by said set of coefficients. The set of coefficients may comprise a respective coefficient (which may be a zero or non-zero value) for each pair of devices of the network of devices. Each coefficient may depend on and/or be calculated using one or more of said set of values representative of distances between respective pairs of devices of the network. In some preferred embodiments, each of the coefficients is a respective linear combination of one or more of the values of the set of values. This can ensure the system of linear equations remains self-consistent and that a solution can be found.

The network of devices may comprise one or more devices having a known location—i.e. for which two-dimensional or three-dimensional coordinates are determined or received before the system of linear equations is solved. The device or devices of known location may comprise mobile devices and/or fixed devices. The known location may be exact or may be an estimate. In some embodiments, the locations of one or more of the mobile devices may be determined, or may have been determined, using other positioning means, such as from GPS measurements. In some embodiments, the network of devices comprises one or more of the devices having a fixed location, such as a static beacon configured to exchange wireless signals with the mobile devices. In some embodiments, the network of devices comprises one or more mobile devices, each configured to determine a position of the mobile device (which may be used as a “known” position) using a positioning method that does not use wireless signals transmitted between the mobile device and other devices of said network of devices—e.g. using a global navigation satellite system (GNSS). Devices of known location may be used to provide an absolute position reference and may be used to determine a respective location of each of the set of one or more mobile devices having unknown location (i.e. devices having locations that are determined by solving the system of linear equations). In particular, a respective two-dimensional or three-dimensional coordinate of one or more devices of known location may be used for determining the two-dimensional or three-dimensional coordinates representative of the respective location of each of the set of one or more mobile devices—e.g. used for determining the set of coefficients for the system of linear equations and/or used for solving the system of linear equations.

In some embodiments, the method comprises determining the location of a single mobile device of the network of devices. The single mobile device may, in some embodiments, be the only mobile device of the network of devices (i.e. with the other devices having fixed locations). However in some embodiments, the method comprises determining the location of a plurality of mobile devices of the network of devices. The network of devices may comprise exclusively mobile devices, or may comprise one or more fixed devices in addition to the set of one or more mobile devices.

In embodiments in which two-dimensional coordinates are determined, the two-dimensional plane may correspond to a physical environment in which the network of devices are located. It may be a horizontal plane. The two-dimensional plane may correspond to a two-dimensional view of, or area in, the real world, which may be an indoor environment, such as a room or a floor of a building. The method may comprise using the determined 2D coordinates to identify one or more respective two- or three-dimensional positions in the environment, e.g. such that a position of each of the set of one or more mobile devices within the room or on the floor of the building may be determined.

In embodiments in which three-dimensional coordinates are determined, the three-dimensional space may correspond to a physical environment in which the network of devices are located. The three-dimensional space may correspond to a three-dimensional volume in the real world, which may be an indoor environment, such as a room or a floor of a building or an entire building. The method may comprise using the determined 3D coordinates to identify respective positions in the environment, e.g. such that a position of each of the set of one or more mobile devices within a room or building may be determined.

One or more of the 2D or 3D coordinates, or positions corresponding to the coordinates, may be output, e.g. as data over a network, or rendered visually on a display screen, such as on a map or plan of an environment in which the network of devices are located. The location system may comprise a display screen for displaying data representative of one or more of the determined coordinates.

The system of linear equations may comprise a plurality of variables corresponding to coordinates of devices of unknown location. It may additionally comprise one or more constant terms corresponding to coordinates of respective devices of known location (although this is not essential in all embodiments or situations).

In some embodiments in which two-dimensional coordinates are determined, the two-dimensional coordinates may be represented as complex values in the complex plane. The two-dimensional coordinates for respective devices may be represented in the system of linear equations by complex values or complex variables. This may allow efficient algorithms to be used to solve the system of linear equations, for example by finding complex eigenvalues.

The system of linear equations may be homogeneous or inhomogeneous. For example, it may be homogeneous if there are no devices of already-known location, and inhomogeneous if coordinates for one or more devices are known.

The system of linear equations may be solved in any appropriate way. In some embodiments, solving the system of linear equations comprises performing singular value decomposition, or performing Gaussian elimination, or performing lower-upper (LU) decomposition.

The set of coefficients may be stored as data representing a square matrix. The square matrix may comprise a respective row and a respective column for each device of the network of devices.

In some embodiments, solving the system of linear equations may comprise calculating an inverse matrix. In such embodiments, the two-dimensional or three-dimensional coordinates may be determined from the product of the inverse matrix and a vector. In such embodiments, the vector may comprise one or more coordinates corresponding to the known locations of one or more devices of the network.

The set of coefficients may be filtered before solving the linear system. It may be filtered by attenuating—e.g. reducing or setting to zero-coefficients, for one or more pairs of devices, that do not meet an inclusion condition. The inclusion condition may specify or determine a maximum number of non-zero coefficients, which may depend on the number of devices or the number of mobile devices (optionally in addition to depending on other factors). This may allow poorer-quality distance data between pairs of devices to be removed, thereby improving the accuracy of the determined mobile device locations. In some embodiments, at least one coefficient is set to zero. By reducing the number of non-zero terms in the system of linear equations, the efficiency with which the system of linear equations can be solved may be improved—e.g. by increasing the sparsity of a matrix representation of the system.

In some embodiments in which two-dimensional coordinates are determined, determining the set of coefficients may comprise, for at least one, or each, device, identifying one or more sets of three further devices of the network. It preferably comprises identifying one or more sets of three further devices that form a respective triangle surrounding said device, in the two-dimensional plane. It may comprise using distances between said device and the three further devices, determined from the distance values, when determining the set of coefficients. Determining the coefficients may comprise performing a bilateration process (e.g. relating to the intersection of circles in two dimensions). It may comprise determining a local coordinate system determined for said device and determining coefficients that represent the locations of the three further devices in said local coordinate system.

Determining the set of coefficients may comprise excluding, from the system of linear equations, distances between said device and any further device that is not part of a set of three devices that satisfies a geometric filter for said device.

In some embodiments, in which two-dimensional coordinates are determined the geometric filter for a device may only pass sets of three further devices that form a triangle that surrounds the device or that is proximate to the device—e.g. for which the distance between said device and a point on the triangle that does not surround the device is within a threshold distance. The threshold distance may be determined based on an uncertainty in the determined distances between pairs of devices of the triangle. Determining the coefficients for the linear system may comprise applying a geometric filter based on Heron's rule.

In some embodiments in which two-dimensional coordinates are determined, coefficients that are associated, in the linear system, with locations of devices forming the triangles may be weighted by a variance determined from an analysis of triangles in the 2D plane. Such a variance may provide a measure of the uncertainty of the relative device locations. In some embodiments a variance is determined for a device surrounded by three further devices, based on a comparison between the area of the triangle formed by the three further devices and the sum of the areas of the three triangles formed by said device and each respective subset of two of the three further devices. In some embodiments, one or more sets of three devices forming a triangle surrounding a device may be excluded based on such a variance. In some embodiments, a plurality of sets of three further devices may be sorted by variance. In some embodiments, only distance values for sets of devices up to a threshold number of (e.g. the top four) sets of devices, ranked by variance, may be considered when determining the coefficients. In some embodiments, for each device, when identifying sets of three devices forming a triangle surrounding said device, the devices may be limited to include only up to a threshold number of (e.g. up to six) other devices. Devices may be selected by favouring devices having a known location and/or lower variance.

In some embodiments in which three-dimensional coordinates are determined, determining the set of coefficients may comprise, for at least one, or each, device, identifying one or more sets of four further devices of the network. It preferably comprises identifying one or more sets of four further devices that form a respective tetrahedron surrounding said device, in the three-dimensional space. It may comprise using distances between said device and the four further devices, determined from the distance values, when determining the set of coefficients. Determining the set of coefficients may comprise performing a trilateration process (e.g. relating the intersection of spheres in three dimensions), which be done in respective of each such set of four further devices. The trilateration process may, in some embodiments, comprise a two-dimensional bilateration operation (e.g. to determine a 2D position of one of the further devices relative to another two of the further devices). It may comprise determining a local coordinate system determined for said device and determining coefficients that represent the locations of the four further devices in said local coordinate system.

In some embodiments in which three-dimensional coordinates are determined, determining the set of coefficients may comprise excluding, from the system of linear equations, distances between said device and any further device that is not part of a set of four devices that satisfies a geometric filter for said device. In some such embodiments, the geometric filter for a device may only pass sets of four further devices that form a tetrahedron that surrounds the device or that is proximate to the device—e.g. for which the distance between said device and a point on the tetrahedron that does not surround the device is within a threshold distance. The threshold distance may be determined based on an uncertainty in the determined distances between pairs of devices of the tetrahedron.

In some embodiments in which three-dimensional coordinates are determined, coefficients that are associated, in the linear system, with locations of devices forming the tetrahedra may be weighted by a variance determined from an analysis of tetrahedra in the three-dimensional space. Such a variance may provide a measure of the uncertainty of the relative device locations. In some embodiments a variance is determined for a device surrounded by four further devices, based on a comparison between the volume of the tetrahedron formed by the four further devices and the sum of the volumes of the three tetrahedra formed by said device and each respective subset of three of the four further devices. In some embodiments, one or more sets of four devices forming a tetrahedron surrounding a device may be excluded based on such a variance. In some embodiments, a plurality of sets of four further devices may be sorted by variance.

In some such embodiments, only distance values for sets of devices up to a threshold number of (e.g. the top four) sets of devices, ranked by variance, may be considered when determining the coefficients. In some embodiments, for each device, when identifying sets of four devices forming a tetrahedron surrounding said device, the devices may be limited to include only up to a threshold number of (e.g. up to six) other devices. Devices may be selected by favouring devices having a known location and/or lower variance.

More generally, in some embodiments, for each mobile device of the set of one or more mobile devices, the number of non-zero coefficients associated with the location of the mobile device in the system of linear equations may be limited by a predetermined maximum threshold number-comprising no more than six non-zero coefficients, irrespective of the number of mobile devices in the network. This can make the system more efficient to solve, and may improve accuracy if data of lower quality is excluded.

In some embodiments in which two-dimensional coordinates are determined, the method may nonetheless be used to determine the location of each of the set of one or more mobile devices in three dimensions. Determining the third coordinate (e.g. corresponding to height or altitude) may be done by a different mechanism—e.g. by selecting the set of one or more mobile devices from a larger group of devices, using a signal strength condition that limits all the devices to being on the same floor of a building (which may then all be assigned a common height value, corresponding to a known height of the floor). In some embodiments, it may comprise solving a further system of linear equations, determined by the set of coefficients, to determine three-dimensional coordinates representative of a respective location of each of the set of one or more mobile devices in three dimensions.

The processing system may comprise one or more processors. It may comprise a single processing device—e.g. a workstation located in the same environment as the mobile devices—or a network of processing devices—e.g. a distributed cloud server accessed over the Internet. It may comprise a memory for storing data and said software. It may comprise one or more wired or wireless network interfaces. It may comprise a display and/or other input-output peripherals.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic drawing of a peer to peer positioning system embodying the invention;

FIG. 2 is a schematic drawing of a static transmitter unit, a mobile device, and a server for use in the peer to peer positioning system;

FIG. 3 is a flow chart of operations carried out by the server to estimate the position of the mobile device in a two-dimensional plane;

FIG. 4 is a schematic diagram of a configuration of devices in a two-dimensional plane determined by the peer to peer positioning system;

FIG. 5 is a schematic diagram illustrating a process of determining relative distances between devices of the peer to peer positioning system in a local coordinate system; and

FIG. 6 is a schematic diagram illustrating a process of determining the position of a device of the peer to peer positioning system in terms of weighted positions of other devices of the peer to peer positioning system;

FIG. 7 is a schematic diagram illustrating a process of selecting subsets of devices to use for determining the position of a particular device of the peer to peer positioning system;

FIG. 8 is a simplified example of a system of linear equations solved by the server to estimate the positions of devices;

FIG. 9 is a flow chart of operations carried out by the server to estimate the position of the mobile device in a three-dimensional space; and

FIG. 10 is a schematic diagram of a configuration of devices in a three-dimensional space determined by the peer to peer positioning system.

### DETAILED DESCRIPTION

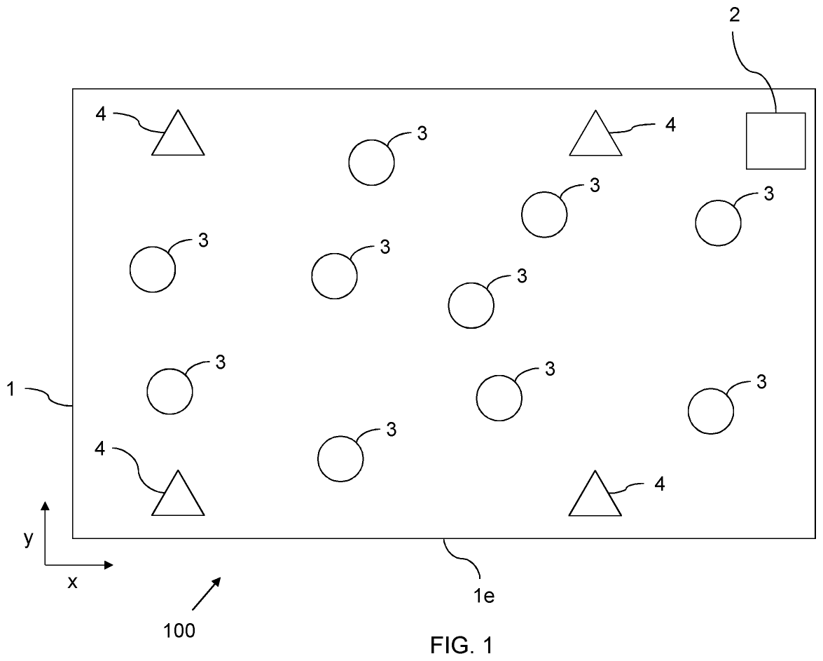

FIG. 1 shows elements of a peer-to-peer positioning (i.e. location-determining) system that may be used in, for example, a shopping mall, in order to determine the locations of shoppers within the shopping mall, by determining the locations of mobile devices, such as smartphones or electronic tags, carried by one or more of the shoppers. Of course, this is just one example environment, and the positioning system could also be used in warehouses, hospitals, domestic homes, vehicles, or many other indoor or outdoor environments.

FIG. 1 shows a top-down view of a single-storey environment 1 (e.g. a room, or a floor of a building) in which a peer to peer positioning system 100 is operating. Other details, such as people, walls, doors, furniture, etc. are omitted for simplicity. The system 100 provides a networked server 2, configured to communicate with a plurality of mobile devices 3, such as smart phones or mobile tags, and static beacons 4. The static beacons 4 are distributed throughout the environment 1 at fixed locations—e.g. fastened to walls or to the ceiling. The mobile devices 3 may move throughout the environment 1, for example being carried by people or fastened to mobile equipment.

The mobile devices 3 are configured to transmit and receive wireless signals, such as Bluetooth Low Energy™, WiFi™ or ultrasound signals, or a combination of different signal types, between one another and to and/or from the static beacons 4. The mobile devices 3 and the static beacons 4 (collectively “devices”) are further configured to communicate with the server 2, which may be direct communication or which may be via other devices—e.g. operating as a wireless mesh network, having any appropriate topology.

These components cooperate to provide a peer to peer positioning system 100, configured to estimate the positions of the mobile devices 3 as two-dimensional (x, y) coordinates within the single-storey environment 1 or as three-dimensional (x, y, z) coordinates. Based on data received at the server 2 relating to wireless signals exchanged by the mobile devices 3 and the static beacons 4, the server 2 is configured to determine locations of the mobile devices 3 as will be described in the following. Although in this embodiment the server 2 is shown within the same environment 1 as the devices 3, 4, in other embodiments it could be located remotely, e.g. at an Internet server farm, and be in communication with one or more of the devices 3, 4 via a network gateway or base station.

While the embodiment shown in FIG. 1 shows a plurality of mobile devices 3, it will be appreciated that the peer to peer positioning system may also or alternatively be used to determine the location of a single mobile device 3, without requiring signal transmissions between the mobile device 3 and any other mobile device of the system, provided that a sufficient number of static beacons 4 are located in the vicinity of the mobile device 3. Thus, the term “peer to peer”, as used herein, should be understood as encompassing “device to device” positioning between devices that may be dissimilar from each other, e.g. between a mobile device 3 and one or more static beacons 4.

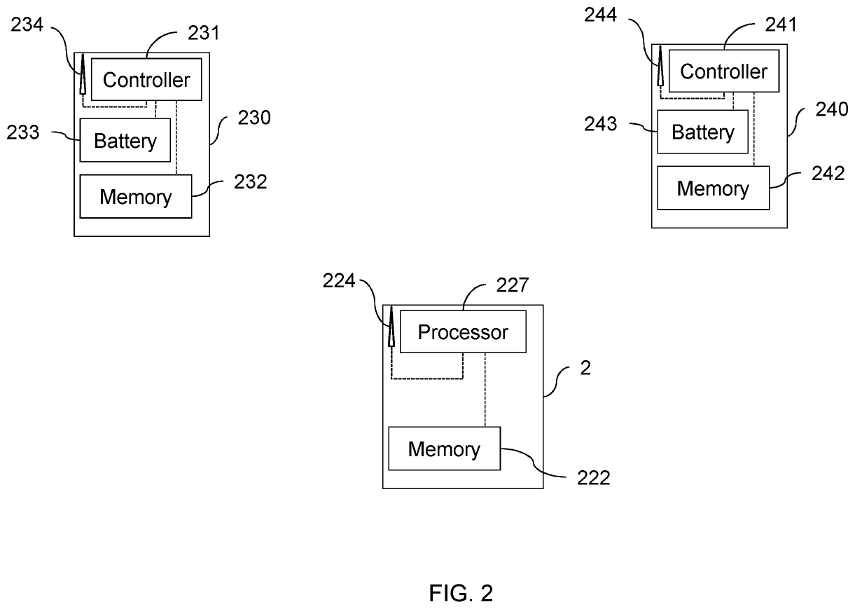

FIG. 2 shows a representative mobile device 230 of the mobile devices 3, a representative beacon 240 of the static beacons 4, and the server 2 in more detail.

The mobile device 230 has a controller 231 comprising a processor and one or more radio modules, a battery 233 for supplying power to the mobile device 230, and a memory 232 for storing data and software 10 for the controller 231. The mobile device 230 also contains an antenna 234, for transmitting and receiving radio signals between the mobile device 230 and other mobile devices 3 and beacons 4 of the peer to peer positioning system 100.

The beacon 240 has a controller 241 comprising a processor and one or more radio modules, a battery 243 for supplying power to the beacon 240, and a memory 242 for storing data and software for the controller 241. The beacon 240 also contains an antenna 244, for transmitting and receiving radio signals between the beacon 240 and other beacons 4 and mobile devices 3 of the peer to peer positioning system. The beacon 240 may also have a wired interface, e.g. for connecting the beacon 240 to the server 2 over a wired Ethernet or fibre optic connection.

The networked server 2 comprises a processor 227 and a memory 222 for storing data and software. It may be static and externally-powered. It may comprise an antenna 224 for direct radio communication with one or more of the mobile devices 3 and beacons 4 of the peer to peer positioning system, or it may have a wired network connection to one or more of the beacons 4, or both. The networked server 2 may be a single physical device, or may be a distributed (e.g. cloud) server system. It may be in the same building, or on the same site, as the mobile devices 3 and static beacons 4, or it may be remote from these components, e.g. in a remote data centre accessed over the internet.

While the devices shown in FIG. 2 comprise respective antennae, they may instead transmit and receive wireless signals other than radio signals, such as ultrasound signals, using acoustic transducers (i.e. loudspeakers and microphones).

In use, each mobile device 3 of the peer to peer positioning system 100 is configured to listen for wireless signals from other mobile devices 3 and beacons 4 of the system 100, and to send wireless messages at regular or irregular intervals, using its antenna 234. Such communications can be used to estimate inter-device distances between pairs of the devices 3, 4 that are in effective communication range of each other, using conventional techniques, such as from received signal strength indicators and/or time-of-flight measurements. For example, distance estimates from a mobile device 3 to one or more other devices 3, 4 may be determined based on one or more received signal strength indicators (RSSI) of BLE advertising messages received by the device 3. In other examples, they could be determined through Bluetooth angle of arrival (AoA), WiFi RSS or round trip time (RTT), ultrawideband (UWB) RTT, ultrasound time of arrival (ToA), ultrasound time difference of arrival (TDoA) measurements, or in any other appropriate way. Such measurements may be processed in any appropriate way in order to determine these inter-device distance estimates (e.g. filtered, averaged, adjusted, combined, etc.).

Inter-device distances between the mobile devices 3 and with the static beacons 4 are determined and stored in the memories 232 of the mobile devices and/or the memories 242 of the static beacons as inter-device distance data. The inter-device distance data is transmitted to the server 2, where it is saved in the memory 222 of the server, and processed by the processor 227 to determine locations of the mobile devices 3. Inter-device distance data may be collected by one or more of the devices 3, 4 and transmitted to the server 2 at intervals, or may be transmitted each time an interaction is recorded between mobile devices 3 and/or static beacons 4. A database of the inter-device distance values between the mobile devices 3 and/or the static beacons 4 is therefore built up and stored in the memory 222 of the server 2, and is updated dynamically as new inter-device distance measurements are recorded.

As the positions of the static beacons 4 are fixed, their absolute locations can be known to the server 2, as (x, y) or (x, y, z) coordinates relative to a predetermined origin and orientation, and hence do not need to be determined using the position determination process. This information may be transmitted to the server 2 during transmission of the inter-device distances, or may be stored in the database at the time the system is set up. The absolute position of certain mobile devices 3 may also be known, for example based on GPS measurements obtained by the devices 3. For example, considering a mobile device 3 initially located outside of the indoor environment shown in FIG. 1, the position of the mobile device 3 may be known based on GPS measurements. When the mobile device 3 enters the indoor environment shown in FIG. 1, and GPS signal is lost, it may begin operating as part of the peer to peer positioning system 100, and may transmit its last position before the GPS signal was lost to the server 2. This may then serve as an absolute position reference for the mobile device 3—i.e. providing a “known” position. Similarly, if the position of a mobile device 3 is known from other sources, its known position may be transmitted to the server 2, e.g. during transmission of the inter-device distances. Known positions serve as reference locations from which the absolute locations of mobile devices 3 of unknown position can be determined. Thus, in some embodiments, the peer to peer positioning system 100 may be able to determine the locations of devices of unknown position based only on the known positions of one or more mobile devices 3, i.e. without necessarily requiring the provision of any static beacons 4 of fixed position.

Having established a database of inter-device distances, the peer to peer positioning system 100 can process the distance values to determine a constellation of the positions of some or all the mobile devices 3 of the system 100 in two- or three-dimensions as will be described in the following. The approach described herein allows the position of mobile devices 3 to be determined indirectly, based at least in part on position estimates calculated for other mobile devices 3. Thus even mobile devices 3 that are not within wireless range of any static beacon 4 can potentially be accurately positioned.

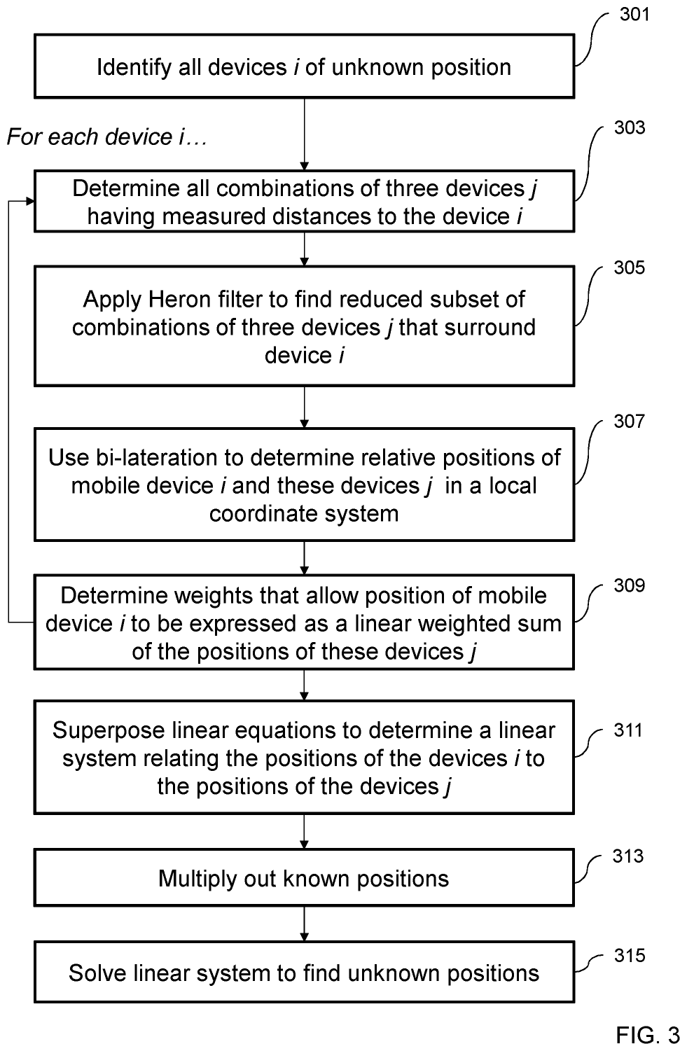

An overview of the position determination process according to a first set of embodiments is illustrated in FIG. 3, which shows a flow chart of operations carried out by the server 2 to estimate the positions of some or all of the mobile devices 3 of the system 100 in a two-dimensional plane.

In step 301, the server 2 identifies all the mobile devices of unknown position.

The server 2 then performs a looped set of steps for each of these devices of unknown location in turn.

In step 303, the server 2 determines, from the inter-device distance values, all combinations of three other devices j (which may be mobile devices 3 or static beacons 4) for which there is recent distance data (i.e. data recorded within a threshold time period, such as 15 seconds) between the device i and the other device j.

In step 305, a reduced subset of combinations of three devices j is determined, which are used in subsequent steps to determine the position of the mobile device i. This subset is chosen based on a condition that the mobile device i should be located within or sufficiently close to a triangle formed by the combination of devices j, in the (x, y) plane. This determination is made using a criteria based on Heron's formula as will be explained below.

In step 307, a bilateration process is used by the server 2 to determine, from the inter-device distance data, the relative positions of the mobile device i and each of the surrounding devices j contained in the subset of combinations, in a local coordinate system.

In step 309, the position zᵢ of the mobile device i is determined in the form of a linear weighted sum of the positions zⱼ of the devices j, i.e. in the form zᵢ=wᵢⱼzⱼ, for real-valued coefficients wᵢⱼ, with the (x,y) positions represented as points in the complex plane by complex values zᵢ and zⱼ.

These steps 303 to 309 are repeated for each device i of unknown location.

Then, in step 311, data (e.g. a matrix of coefficients) representing a system of linear equations is generated, in which the position of every device 3, 4 in the system 100 is expressed in terms of a respective weighted sum of positions of relevant other devices. The matrix may optionally be filtered to increase its sparsity.

In step 313, the terms of the matrix relating to devices 3, 4 with already-known positions are multiplied out, in order to reduce the size of the matrix by the number of known device positions.

In step 315, the system of linear equations is solved (e.g. by inverting the remaining matrix), to determine a vector containing the positions of the mobile devices 3 of previously unknown position in a two dimensional plane.

Having outlined the process by which the position determination process is performed by the server 2, the steps of the process according to this first set of embodiments will now be described in more detail with reference to FIGS. 3-7.

Within the first step 301, all devices (i.e. mobile devices 3 and beacons 4) to be positioned within an area or environment are identified. This may be all of the devices located on a floor, or in a room of a building, or may be all of the devices of the peer to peer positioning system 100. The selection of devices within a room or limited to a floor of a building may be made based on a level of attenuation of signals transmitted between devices. High-frequency signals in the ISM band (2, 4 and 5 GHz) experience very high attenuation when crossing walls and floors, and hence devices in a common room or floor can be easily grouped. Thus a third-dimension of height (e.g. which storey a device is on) may be determined before the present two-dimensional positioning process is initiated, such that two-dimensional (x, y) coordinates in the horizontal plane may also be sufficient for resolving the location of a device in three dimensions (x, y, z) if required. Alternatively, as will be described below, a second set of embodiments use a variant process that can directly determine device positions in three-dimensions, from the wireless signals.

An inter-device distance graph for all of the selected devices is already determined by data stored in a database of the server 2, including the inter-device distances of the selected devices, and an indication of whether the position of each of the devices is known or unknown. As described above, known device positions include the position of the static beacons 4 and the position of any mobile device 3 whose absolute position is known from other means, for example from GPS measurements. These locations may be determined by latitude & longitude, or relative to a predetermined local coordinate system for the environment 1, or in any other appropriate way. Using the inter-distance device graph, the relative positions of the selected devices are then determined as will be described in the following.

The positioning method according to this first set of embodiments, as described below, exploits the fact that, if the devices are considered to be located on a 2D plane (which is a reasonable assumption in many cases, such as when the devices are known to all be on the same floor of a building), the position of each device can be expressed as a linear combination of the 2D positions of the devices that surround it. The resulting system of linear equations can be solved simultaneously, to determine estimates for a plurality of devices simultaneously.

The surrounding devices may all be mobile devices or may all be fixed beacons, or may be any combination of mobile and fixed devices.

In step 303, for a given mobile device i with unknown position zᵢ, the server 2 determines every combination of three other devices j. This may be achieved using conventional methods for finding all C(N, 3) (i.e. “N choose 3”) sets, such as using a Cartesian product list.

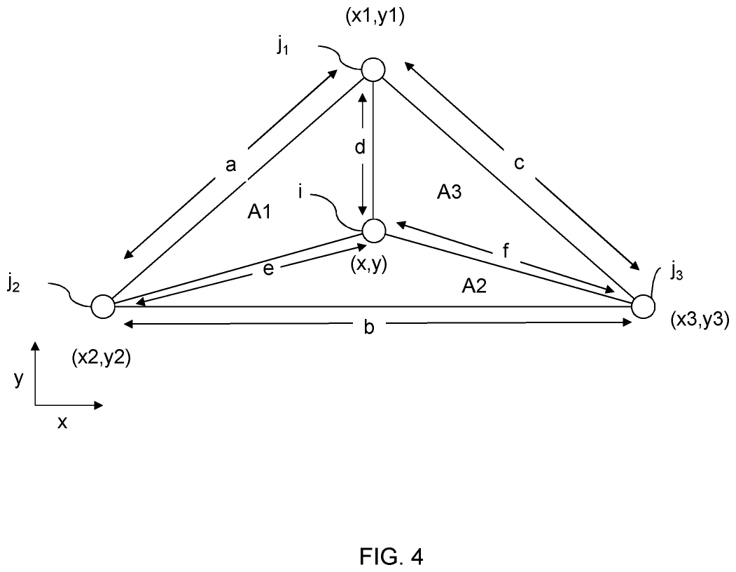

In step 305, these are filtered to find only those combinations having positions zⱼ forming a triangle surrounding, or nearly surrounding (i.e. close to), the position zᵢ. This is done by applying a geometric filter based on Heron's rule. An exemplary combination of three devices j identified in this way is shown in FIG. 4.

FIG. 4 shows a mobile device i at a position zᵢ (represented by coordinates (x,y) in the 2D plane) surrounded by three mobile devices j₁, j₂, j₃ located at positions zⱼ₁, zⱼ₂, zⱼ₃ respectively (and represented by coordinates (x₁,y₁), (x₂,y₂), (x₃,y₃) in the 2D plane). The six pairwise inter-device distances between each of the four mobile devices, determined by wireless ranging and stored in the memory 222 of the server 2, are shown in FIG. 4 as distances a-f.

These inter-device distances a-f are used to determine whether the mobile device i lies within, or close to, a triangle defined by the positions zⱼ of the devices j₁, j₂, j₃ in the x-y plane, by considering the respective areas of triangles formed by the device positions. The area of the largest triangle formed by the devices j₁, j₂, j₃, shown in FIG. 4 with edges a-b-c, and the areas of the three inner triangles, having edges a-d-e, d-c-f and e-f-b respectively, can be calculated using Heron's rule, which states that the area A of a triangle having sides of lengths p, q and r, equals:

$$A = \sqrt{s ( s - p ) ( s - q ) ( s - r )}$$

where s is the semi-perimeter of the triangle, given by:

$$s = \frac{p + q + r}{2}$$

Using the above equations, the server 2 determines whether the three devices j₁, j₂, j₃ of every possible combination surround the mobile device i by comparing the sum of the areas of the inner triangles a-d-e, d-c-f, and e-f-b (shown as A1, A2, A3 in FIG. 4) to the area A of the outer triangle a-b-c. If the device i is contained within the triangle, these two values will be equal, or approximately equal when allowing for measurement errors.

As the inter-device distances determined using RSSI measurements in the peer to peer positioning system 100 have some associated error, a relaxed comparison of the areas is made according to:

$$\frac{1}{area\_factor} \times A < A 1 + A 2 + A 3 < area\_factor \times A$$

where area_factor is selected based on properties of the peer to peer positioning system, such as an expected RSSI error, and is typically in the range 1≤ area_factor≤3.

By applying this geometric condition to the distance data for each combination of three devices, all the combinations that effectively surround the mobile device i can be determined.

For each combination of devices that satisfy the above condition, a measure of uncertainty of the relative device positions may be determined by comparing the variance of the inner triangle areas pos_var_area_i=Var(\sqrt{A1}, \sqrt{A2}, \sqrt{A3}) to the mean area \sqrt{A/3}. The results of this comparison may be used to determine a reduced subset of combinations of three devices to be used in later calculations, e.g. by excluding combinations of devices which form triangles for which the uncertainty is high, such as above a threshold. In some but not all embodiments, it may be used by the server 2 to influence the calculation of the coefficients wᵢⱼ in the linear weighted sum.

Having determined all possible combinations of three devices j₁, j₂, j₃ surrounding the mobile device i for which a complete inter-device distance set is available (i.e. having six known inter-device distances between the four devices involved), the server 2 then, in step 307, determines the relative positions of the devices i and j₁, j₂, j₃ in a local coordinate system.

The position of the device i is determined within a local reference frame defined by the devices j₁, j₂, j₃ by performing a series of bilaterations—that is, by selecting an arbitrary reference frame in which the position of one of the devices, e.g. j₂ in FIG. 4, is equal to (0,0) and the position of another of the devices, e.g. j₃ in FIG. 4, is equal to (b,0), the position of the final device, e.g. j₁, can be calculated in this local coordinate system from the known distances a, b, c using bilateration (i.e. based on the intersection of circles in the plane). Further bilaterations allow the position of the mobile device i to be similarly determined.

For a triangle of arbitrary coordinates (x1,y1), (x2,y2), (x3, y3), with distance r1 between (x1,y1) and (x2,y2), and distance r2 between (x1,y1) and (x3,y3), the position of (x1,y1) is given by

$$l = \frac{{r}_{1}^{2} - {r}_{2}^{2} + {D}^{2}}{2 D}$$

$$h = \sqrt{{r}_{1}^{2} - {l}^{2}}$$

$$where$$

$$D = \sqrt{{( {x}_{2} - {x}_{3} )}^{2} + {( {y}_{2} - {y}_{3} )}^{2}}$$

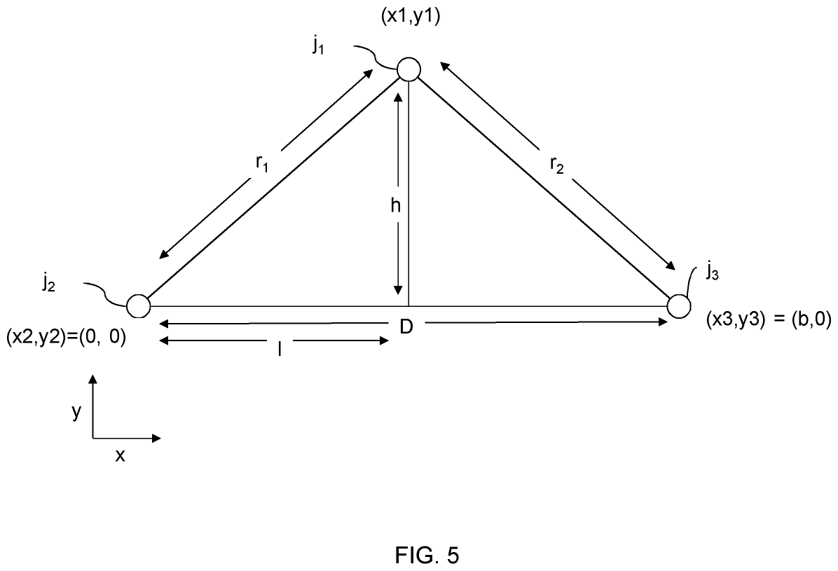

FIG. 5 shows an example of applying this to the outer triangle from FIG. 4, to express the position of the device j₁ as (x1,y1)=(l, h), where r₁ is the measured distance between j₂ & j₃ (equal to “a” from FIG. 4), r₂ is the distance between j₁ & j₃ (equal to “c” from FIG. 4), and D is the distance between j₂ &j₃ (equal to “b” from FIG. 4).

Once the positions of the devices j₁, j₂, j₃ are determined in a local coordinate system, the bilateration process is repeated for each of the three inner triangles to determine respective estimates of the position of the mobile device i, located within the triangle formed by devices j₁, j₂, j₃ in the local coordinate system.

While successive bilaterations could lead to increased complexity, as two solutions (+h,-h) are possible, by ensuring that a consistent order of the devices is maintained when assessing subsequent bilaterations, the positive h solution can be consistently selected. The three bilateration results are rotated using the orientations of the respective baseline sides to align with the original local reference frame defined by the edges a,b,c.

The three bilateration position estimates obtained for each sub-triangle will typically differ due to measurement noise. This provides a good way of assessing the variance of the position (pos_variance) estimate for the mobile device i by calculating the second norm with respect to the mean position. This true positional variance may be used, in some embodiments, to weight the coefficients by a factor 1/pos_variance.

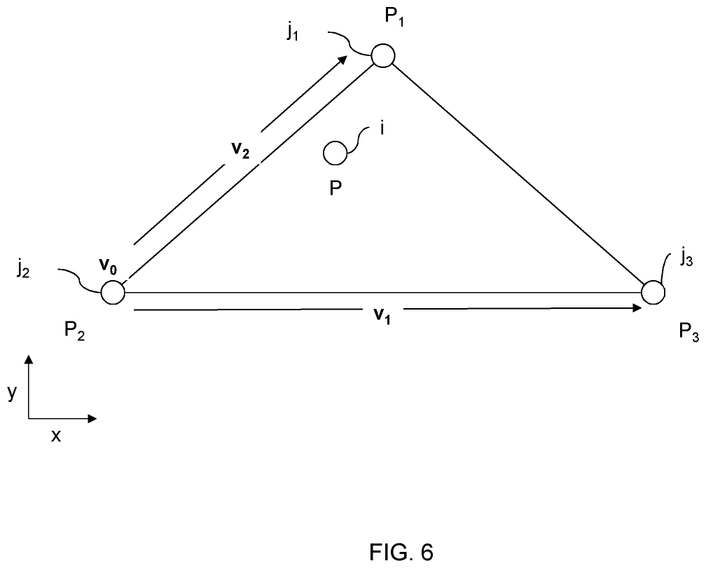

Having determined a position estimate zᵢ for the mobile device i in the local coordinate system defined by the triangle a-b-c, its position zᵢ can be mapped back to the positions zⱼ of the devices j₁, j₂, j₃ by the coefficient factors wᵢⱼ. The position zᵢ of the mobile device i can be expressed in terms of the device positions j₁, j₂, j₃ in vector notation. The theory behind this is illustrated with reference to FIG. 6.

FIG. 6 shows a triangle formed from devices j₁, j₂, j₃, within which a mobile device i is located. The position P of the mobile device i can be expressed as a two-dimensional vector in terms of the positions P₁, P₂ and P₃ (equivalent to zⱼ₁, zⱼ₂ and zⱼ₃ respectively) of the devices j₁, j₂, j₃. The server 2 may, in some embodiments, be configured to perform calculations on these positions by representing them as complex numbers in the complex plane.

Specifically, the position P of the mobile device i can be written in terms of a vector v from v₀ to the position P of the mobile device i as:

$$v = {v}_{0} + ∝ {v}_{1} + β {v}_{2}$$

where v₁ and v₂ are the vectors from v₀ to the two other vertices of the triangle, and where α and β are constants.

Solving for α and β gives:

$$\begin{matrix}α = \frac{det ( {vv}_{2} ) - det ( {v}_{0} {v}_{2} )}{det ( {ν}_{1} {ν}_{2} )} \\ β = - \frac{det ( {vv}_{1} ) - det ( {v}_{0} {v}_{1} )}{det ( {v}_{1} {v}_{2} )}\end{matrix}$$

where det(uv) is the determinant of the matrix formed by the column vectors u and v given by:

$$det ( uv ) = u \times v = {u}_{x} {v}_{y} - {u}_{y} {v}_{x}$$

By calculating α and β, and writing the vectors v₁ and v₂ in terms of the vertex positions P₁, P₂ and P₃ as v₁=P₁−P₂ and v₂=P₃−P₂, the position P of the mobile device i can be determined as

$$P = {P}_{2} + α ( {P}_{1} - {P}_{2} ) + β ( {P}_{3} - {P}_{2} ) = ( 1 - α - β ) {P}_{2} + α {P}_{1} + β {P}_{3}$$

Taking γ=1−(α+β), the real-valued coefficient wᵢⱼ for each device j₁, j₂, j₃ can be calculated by the server 2 in terms of the constants α, β and γ, such that the position of the mobile device i can be expressed in terms of the positions of the surrounding devices j₁, j₂, j₃.

The above calculation of α, β also provides another means for checking that the position of the mobile device i is inside of the triangle formed by the devices j, which is true only if α, β>0 and α+β<1. In some embodiments, if this relationship is not satisfied, the results are discarded.

Following the above calculations, α, β and γ are the normalised weights for each triangle's node positions. These can be further weighted using the positional variance found for the specific triangle, as described above, such that the coefficients are further weighted by a factor of 1/pos_variance. The coefficients are therefore able to account for positioning inaccuracy of the devices. Further weighting of the coefficients may be applied based on the recency (i.e. freshness) of the distance data used to determine the positional variance. This may be achieved by multiplying the positional variance by a pre-factor that decreases linearly with time up to a threshold time (e.g. 15 seconds), after which the pre-factor is reduced to zero.

Additional sources of positioning error may optionally be taken into account by further modifying the weighting of the coefficients. For example, in the case where the position of one or more of the devices is “known”, e.g. from a GPS measurement, its “known” position may still have an associated error due to positional measurement inaccuracy. In this case, the uncertainty in the device's position may be taken into account, e.g. by adding a variance term, based on the positional measurement inaccuracy, to the positional variance pos_variance. To estimate the impact of positional variance from one or more of the devices j on the variance of device i, the variances may be propagated using the method of partial derivatives for each triangle, such that:

$${( d {z}_{i} )}^{2} = {( \frac{d F}{d {z}_{j}} )}^{2} {( d {z}_{j} )}^{2}$$

where F is the functional relationship between zᵢ and zⱼ.

The above processes allow the server 2 to determine the position zᵢ of a mobile device i as a consistent linear combination of the positions zⱼ of devices j that surround it, each weighted by a coefficient wᵢⱼ.

The applicant has recognised that by determining coefficients using the process described above, a self-consistent system of linear equations can be established that relates the positions of devices of the peer to peer positioning system to each other.

If the 2D coordinates of the devices are considered as complex numbers in the complex plane, and represented as a column vector for the set of all M devices (including those of known and unknown positions), the system can be expressed as a 2D matrix equation, with matrix elements corresponding to the coefficients wᵢⱼ, such that

$${z}_{i} = {\sum }_{j \neq i} {w}_{i j} {z}_{j}$$

If the diagonal terms are set such that

$${w}_{i i} = - {\sum }_{j \neq i} {w}_{i j}$$

then this is equivalent to

$${\sum }_{j = 1}^{N} {w}_{i j} {z}_{j} = 0$$

which can be expressed in matrix form as

$$[ \begin{matrix}{w}_{11} & … & {w}_{1 M} \\ ⋮ & ⋱ & ⋮ \\ {w}_{M 1} & … & {w}_{MM}\end{matrix} ] \cdot [ \begin{matrix}{z}_{1} \\ ⋮ \\ {z}_{M}\end{matrix} ] = [ \begin{matrix}0 \\ ⋮ \\ 0\end{matrix} ]$$

If the server 2 can determine sufficiently many non-zero coefficients for pairs of devices forming part of the peer to peer positioning system 100, the position of every device zⱼ can be simultaneously calculated through conventional techniques for solving linear systems. The server 2 may be configured to solve the system of linear equations by any appropriate method.

If the position of some devices 3, 4 is known, the terms of the matrix relating to any devices with known positions, zₖ, may be multiplied out by the server 2 prior to solving the linear system, in order to reduce the size of the matrix by the number of known device positions.

For example, in a system comprising N mobile devices of unknown position and k devices of known position (e.g. static beacons and/or mobile devices having known positions), the matrix equation may be represented as

$$W \cdot z = 0 ↔ [ \begin{matrix}{w}_{1 , 1} & … & {w}_{1 , N} & {w}_{1 , N + 1} & … & {w}_{1 , N + k} \\ ⋮ & ⋱ & ⋮ & ⋮ & ⋰ & ⋮ \\ {w}_{N , 1} & … & {w}_{N , N} & {w}_{N , N + 1} & … & {w}_{N , N + k} \\ {w}_{N + 1 , 1} & … & {w}_{N + 1 , N} & {w}_{N + 1 , N + 1} & … & {w}_{N + 1 , N + k} \\ ⋮ & ⋰ & ⋮ & ⋮ & ⋱ & ⋮ \\ {w}_{N + k , 1} & … & {w}_{N + k , N} & {w}_{N + k , N + 1} & … & {w}_{N + k , N + k}\end{matrix} ] \cdot [ \begin{matrix}{z}_{1} \\ ⋮ \\ {z}_{N} \\ {z}_{N + 1} \\ ⋮ \\ {z}_{N + k}\end{matrix} ] = [ \begin{matrix}0 \\ ⋮ \\ 0\end{matrix} ]$$

Because the device positions z_{N+1} to z_{N+k} are known, these can be separated out as

$$[ \begin{matrix}{w}_{1 , 1} & … & {w}_{1 , N} \\ ⋮ & ⋱ & ⋮ \\ {w}_{N , 1} & … & {w}_{N , N}\end{matrix} ] \cdot [ \begin{matrix}{z}_{1} \\ ⋮ \\ {z}_{N}\end{matrix} ] + [ \begin{matrix}{w}_{1 , N + 1} & … & {w}_{1 , N + k} \\ ⋮ & ⋱ & ⋮ \\ {w}_{N , N + 1} & … & {w}_{N , N + K}\end{matrix} ] \cdot [ \begin{matrix}{z}_{N + 1} \\ ⋮ \\ {z}_{N + k}\end{matrix} ] = [ \begin{matrix}0 \\ ⋮ \\ 0\end{matrix} ]$$

The known positions z_{N+1} and z_{N+k} and the calculated coefficients relating to the devices of known position can be expressed as a constant vector b, leading to an inhomogeneous matrix equation,

$${W}_{1 : N , 1 : N} \cdot {z}_{1 : N} = {b}_{1 : N}$$

where the values of b are calculated according to

$${b}_{j} = - {\sum }_{k = 1}^{N} {w}_{j , N + k} \cdot {z}_{N + k}$$

$$for j = [ 1 , N ] .$$

The server 2 can find a solution to this inhomogeneous matrix equation, for the unknown positions z₁ to z_{N}, using conventional techniques, such as singular value decomposition, Gaussian elimination, or lower-upper (LU) decomposition to determine the unknown positions of the devices z₁ to z_{N}.

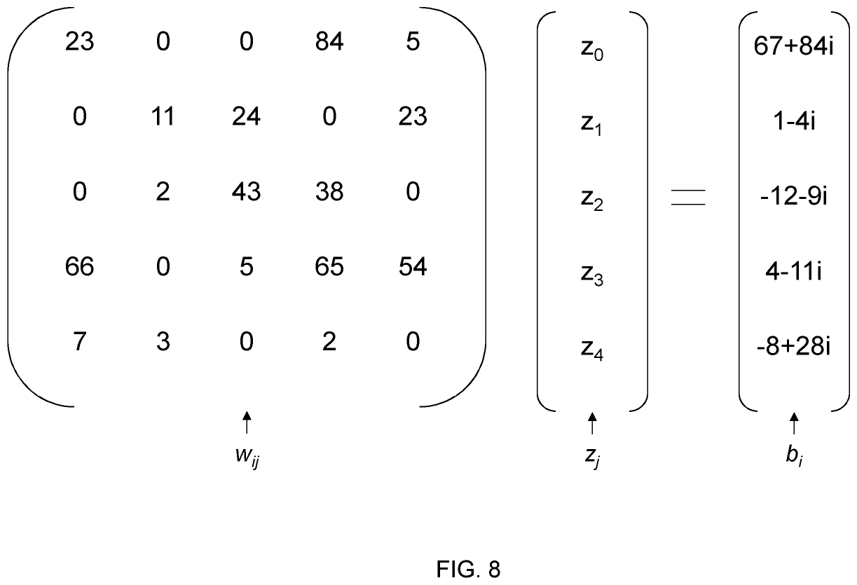

FIG. 8 provides a simplified example of such a system of linear equations, showing a matrix, wᵢⱼ, of real-valued weight coefficients, a vector zⱼ of unknown device positions (where each zⱼ is the complex number formed from the device's Cartesian coordinates as xⱼ+i·yⱼ), and a vector bᵢ which is calculated by the server 2 as −sum(wᵢₖ zₖ) from the positions, zₖ, of k known devices.

The server 2 may combine as many triangles as possible to populate the matrix wᵢⱼ. However, for high device counts it is advantageous to keep the matrix wᵢⱼ sparse, such that less computationally intensive methods for solving the linear system (e.g. for performing matrix inversion) may be used. It may therefore be beneficial, at least in some embodiments, for the server 2 to filter the matrix by setting some coefficients to zero (or otherwise attenuating them). It may do this by imposing a maximum number of triangles to be used for determining the coefficients for each device i, such as four triangles. It may additionally or alternatively impose a minimum number of non-zero matrix elements (coefficients wᵢⱼ), such as a minimum of four—i.e. it may keep adding triangles until the minimum is reached for each row. It may additionally or alternatively impose a maximum number of non-zero matrix elements, such as a maximum of six, that are allowed in each row. By applying both a minimum and maximum number of allowed non-zero elements per row, computational efficiency can be optimised while ensuring a sufficient number of device counts to be able to effectively determine device positions.

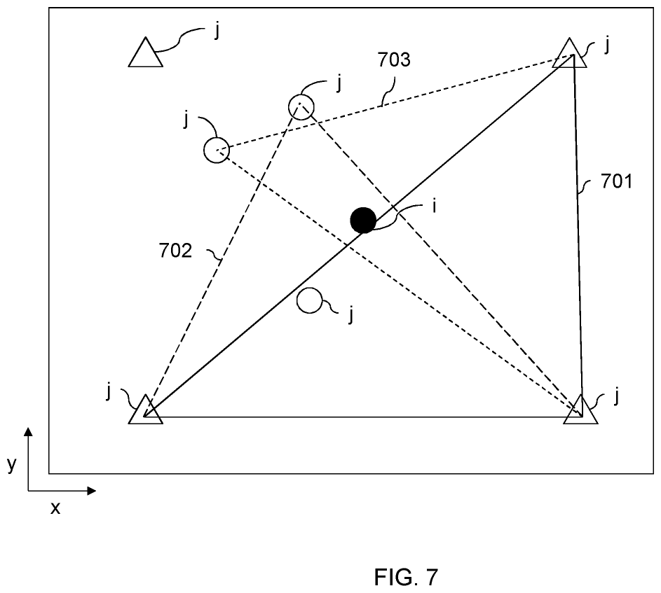

An example of such a filtering can be explained with reference FIG. 7, which shows a mobile device i of the peer to peer positioning system 100 surrounded by seven other devices j including four static beacons (shown as triangles in FIG. 7) and three other mobile devices (shown as empty circles in FIG. 7). In FIG. 7, three triangles 701-703 have been selected by the server 2 to be used to determine the coefficients for the system of linear equations in respect of the mobile device i. FIG. 7 also illustrates how the Heron criterion may, in some situations, allow a triangle 701 to be used even when the mobile device i actually lies just outside the triangle 701, because of the error margin.

When selecting a subset of triangles to be used, two classes of triangles can be set: a first class of those triangles having at least one apex defined by a beacon 4 or device 3 of known location, and a second class of triangles which do not have this.

Thus, triangles may be formed exclusively from beacons 4 or exclusively from mobile devices 3, or by any combination of beacons 4 and mobile devices 3.

Preferably, when selecting a reduced subset of triangles to be used (e.g. restricting to four triangles), the server 2 favours selecting triangles from the first class. For devices in the same class, it may be configured to select triangles in order of lowest positional variance. This typically favours the surrounding triangles with the smallest sides.

Devices 3, 4 that do not have any valid surrounding triangle of nodes or have no nearby triangles to support extrapolating are removed from the coefficient matrix wᵢⱼ and do not have their positions determined with the method described above. However, in some cases where α mobile device i is not surrounded by any triangle of other devices, the server 2 may be able to include it by a process of extrapolation. It may attempt to add the mobile device to the linear system of device positions using a trilateration result from the closest triangles. The coefficients wᵢⱼ can be constructed in the same way as when a point is inside a triangle, but extrapolated rather than interpolated.

One complexity that does arise when using extrapolation is that, in contrast to when a node is inside a triangle, each of the three bilaterations from a nearby triangle results in two valid positions, resulting in a total of 2³=8 different combinations. To select the true estimated position, the position error for each combination may be calculated and the position with the smallest associated error selected.

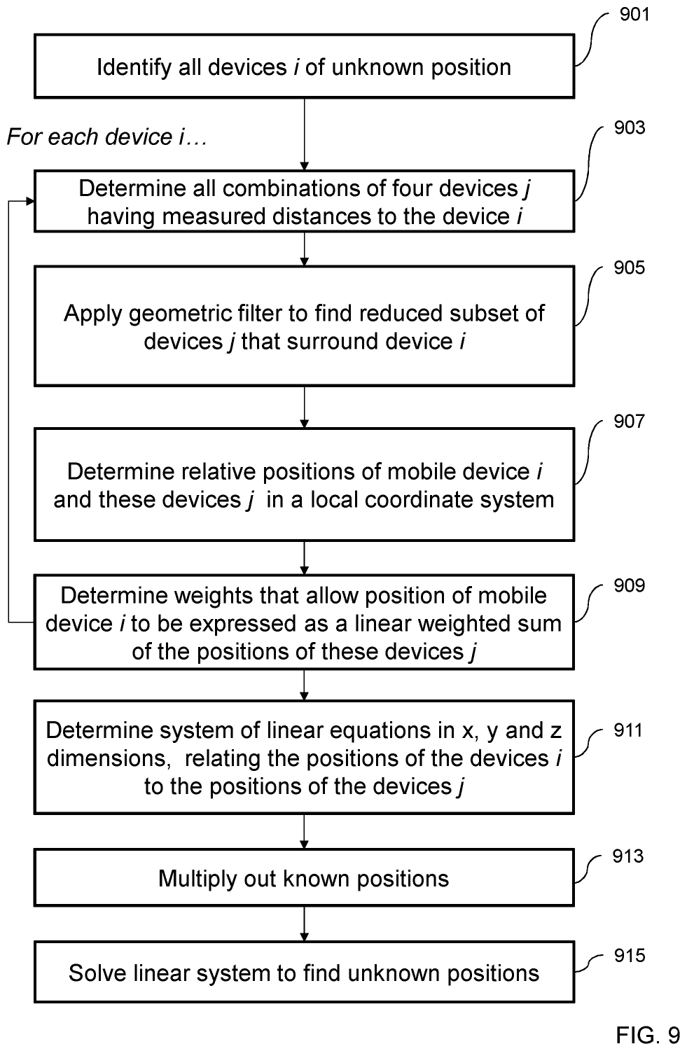

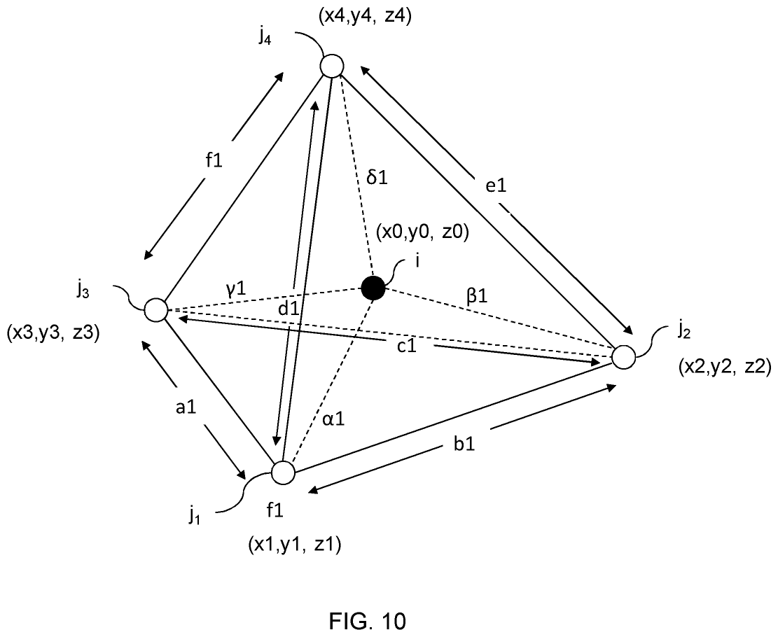

While the method described in relation to FIGS. 3 to 8 is sufficient for the determination of device positions in two dimensions, as may be useful for determining the locations of customers within a particular floor (storey) of a shopping mall for example, the inventors have also recognised that wireless signals as disclosed herein can also be used for directly determining device positions in three dimensions. Thus a second set of embodiments will now be described, with reference to FIGS. 9 and 10, that performs direct 3D positioning.

Similarly to the two-dimensional case described above, determination of device positions in three dimensions can be achieved using the peer to peer positioning system 100 shown in FIG. 1, based on the determination of inter-device distances between pairs of mobile devices 3 and static beacons 4 and the subsequent processing of these distances using a server 2. In the three-dimensional case, inter-device distances are determined in a manner equivalent to that described above (e.g. using RSSI measurements), and are saved to the memory 222 of the server 2 in a database in the form of inter-device distance data. The positions of the static beacons may be known to the server as three-dimensional (x, y, z) coordinates relative to a predetermined origin and orientation.

The peer to peer positioning system 100 can process the inter-device distance data to determine a constellation of the positions of some or all of the mobile devices 3 of the system 100 in three-dimensional space as will be described in the following. The position of each device can then be expressed as a linear combination of the 3D positions of the devices that surround it, and the resulting system of linear equations can be solved simultaneously, to determine estimates for a plurality of devices simultaneously.

An overview of the three-dimensional position determination process is illustrated in FIG. 9, which shows a flow chart of operations carried out by the server 2 to estimate the positions of some or all of the mobile devices 3 of the system 100 in a three dimensional space. This process is described below, with further reference to FIG. 10.

In the first step 901, all of the devices (i.e. mobile devices 3 and beacons 4) to be positioned within an area or environment are identified, and an inter-device distance graph for all of the selected devices (including devices having unknown positions and those whose positions are known, e.g. from GPS measurements) is generated, in a manner equivalent to that described in relation to step 301 of FIG. 3.

In step 903, for a given mobile device i with unknown position qᵢ the server 2 determines every combination of four other devices j (which may be mobile devices 3 or static beacons 4) for which there is recent distance data (i.e. data recorded within a threshold time period, such as 15 seconds) between the mobile device i and the other devices j. As described above in relation to the 2D case, this may be achieved using conventional methods for finding all C(N, 4) (i.e. “N choose 4”) sets, such as using Cartesian product list.

These are filtered, in step 905, to generate a reduced subset of combinations of four devices j having positions qⱼ forming a tetrahedron surrounding, or nearly surrounding, the position qᵢ in 3D space. This is conceptually similar to the determination of surrounding triangles of the 2D case, but relies on the use of tetrahedra in place of triangles. This determination is made using a criteria based on a formula similar in principle to that of Heron's rule as will be explained below in relation to FIG. 10.

FIG. 10 shows a mobile device i at a position qᵢ (represented by coordinates (x₀, y₀, z₀) surrounded by four mobile devices j₁, j₂, j₃, j₄ located at positions qⱼ₁, qⱼ₂, qⱼ₃ and qⱼ₄ respectively (and represented by coordinates (x₁,y₁,z₁), (x₂,y₂,z₂), (x₃,y₃,z₃) and (x₄,y₄,z₄)). The mobile devices j₁-j₄ sit at the corner points of a tetrahedron surrounding the mobile device i in 3D space. The inter-device distances between each of the mobile devices j₁-j₄ are shown in FIG. 10 as a₁-f₁, while the distances between the mobile device i and the surrounding devices j₁-j₄ are shown as α₁, β₁, δ₁ and γ₁.

While FIG. 10 shows a mobile device i surrounded by four further mobile devices j₁-j₄ it will be appreciated that any or all of the surrounding mobile devices j₁-j₄ could instead be respective fixed beacons 4.

The inter-device distances are used to determine whether the mobile device i lies within, or close to, a tetrahedron defined by the positions qⱼ of the devices j₁-j₄. This is achieved by comparing the combined volume, V_{T}, of the sub-tetrahedra formed by three of the four devices j₁-j₄ and the mobile device i, and having volumes V₁-V₄ respectively. In other words, a determination is made as to whether:

$${V}_{T} = {V}_{1} + {V}_{2} + {V}_{3} + {V}_{4}$$

In terms of the device positions, this can be expressed as

$${V}_{T} ( {j}_{1} , {j}_{2} , {j}_{3} , {j}_{4} ) = V ( i , {j}_{2} , {j}_{3} , {j}_{4} ) + V ( i , {j}_{1} , {j}_{3} , {j}_{4} ) + V ( i , {j}_{1} , {j}_{2} , {j}_{4} ) + V ( i , {j}_{1} , {j}_{2} , {j}_{3} )$$

where V(j₁,j₂,j₃,j₄) is the volume of the tetrahedron with vertices j₁, j₂, j₃, j₄. When comparing the combined volume V_{T} to the volume of the sub-tetrahedra using this equation, the equality will hold for any position inside the tetrahedron, while the combined volume of the sub-tetrahedra will exceed V_{T} for any position outside the combined tetrahedron. Thus, if the mobile device i is contained within the combined tetrahedron of volume V_{T}, the two sides of the equation above will be equal, or approximately equal when allowing for measurement errors.

The volume of a tetrahedron can be computed using the length of its sides, using existing formulae similar in principle to that of Heron's rule described above in relation to the two-dimensional case. In general, for a tetrahedron with vertices pₐ, p_{b}, p_{c}, p_{d}, the volume Vₜₑₜᵣ of the tetrahedron can be given according to the following:

$${V}_{tetr} ( {p}_{a} , {p}_{b} , {p}_{c} , {p}_{d} ) = \sqrt{\frac{\begin{matrix}( - p + q + r + s ) ( p - q + r + s ) \\ ( p + q - r + s ) ( p + q + r - s )\end{matrix}}{192 uvw}}$$

$$where$$

$$p = \sqrt{xYZ} , q = \sqrt{yZX} , r = \sqrt{zXY} , s = \sqrt{xyz}$$

$$X = ( w - U + v ) ( U + v + w ) , z = ( U - v + w ) ( v - w + U )$$

$$Y = ( u - V + w ) ( V + w + u ) , y = ( V - w + u ) ( w - u + V )$$

$$Z = ( n - W + u ) ( W + u + v ) , z = ( W - u + v ) ( u - v + W )$$

$$and$$

$$u = ‖ {p}_{b} - {p}_{a} ‖ , U = ‖ {p}_{d} - {p}_{c} ‖$$

$$v = ‖ {p}_{c} - {p}_{a} ‖ , V = ‖ {p}_{d} - {p}_{b} ‖$$

$$w = ‖ {p}_{d} - {p}_{a} ‖ , W = ‖ {p}_{c} - {p}_{b} ‖$$

Thus, by inputting the inter-device distances a₁-f₁ between the devices j₁-j₄ and the device i into the equations above, the volume V_{T} of the tetrahedron formed by the devices j₁-j₄, and the volumes of each of the sub-tetrahedra V₁-V₄ formed by the device i and three of the devices j₁-j₄, can be determined and compared by the server 2. This method therefore allows determination of whether the device i is contained within the tetrahedron formed by the devices j₁-j₄ based only on the inter-device distances a₁-f₁.

By applying a geometric condition to the distance data in this way for each combination of four devices, all the combinations of devices j that effectively surround the mobile device i can be determined in a similar manner to described above in relation to the 2D case.

A volume factor may be applied, similarly to the area factor of the 2D case, to account for errors arising from the fact that the inter-device distances are determined using RSSI measurements with an associated error. This may allow for a more relaxed comparison to be made between the volumes than the strict equality defined above. The volume factor may therefore be selected based on properties of the peer to peer positioning system, such as an expected RSSI error. Similarly to the two-dimensional case, a measure of uncertainty in device position may be determined—in particular, the server 2 may, for each combination of surrounding devices, evaluate a measure of uncertainty in the relative device position resulting from that combination by comparing the variance of the inner sub-tetrahedral volumes to the mean volume of the tetrahedron. The server 2 and may use these uncertainty measures to determine a reduced subset of combinations of devices excluding those combinations with high uncertainty (e.g. above a threshold level).

Having determined all possible combinations of four devices j₁, j₂, j₃, j₄ surrounding the mobile device i for which a complete inter-device distance set is available (i.e. having ten known inter-device distances between the five devices involved), the server 2, in step 907, determines the relative positions of the mobile devices i and the devices j₁, j₂, j₃, j₄ in a local coordinate system.

Using the labelling system shown in FIG. 10, to achieve this, the position of a first one of the devices j₁, j₂, j₃, j₄, for example j₁, is selected as an origin, i.e. having coordinates (x₁,y₁,z₁)=(0,0,0). The position qⱼ₂ of a second one of the devices, e.g. j₂, is then defined as lying on the x-axis, such that it has coordinates (x₂,y₂,z₂)=(b₁, 0, 0). The position qⱼ₃ of a third one of the devices, e.g., j₃, is used to define an x-y plane such that j₃ lies in this x-y plane. The coordinates (x₃,y₃,z₃) of this point are found using circle-based bilateration, to define the coordinates of the third of the devices as

$${q}_{j 3} = ( {a}_{1} \cdot cos ∅ , {a}_{1} \cdot sin ∅ , 0 )$$

where Ø is the angle between a₁ and b₁, and can be given by:

$$∅ = {cos}^{- 1} ( \frac{{a}_{1}^{2} + {b}_{1}^{2} - {c}_{1}^{2}}{2 {a}_{1} {b}_{1}} )$$

The position of the fourth one of the devices, e.g. j₄, is then defined as lying above the x-y plane with a positive height in the z-direction. The coordinates of this point may be found using sphere-based trilateration. In this process, the location of each of the devices j₁, j₂ and j₃, now defined as lying in the plane z=0, is set as the centre of a sphere, the radii of which may be defined as rⱼ₁, rⱼ₂ and rⱼ₃ respectively. Two intersection points (one above and one below the z-axis) can be determined for the three spheres by defining the radii of the spheres in terms of the x, y, z coordinates of the position of the fourth of the devices, and solving for x, y and z. Although two intersection points are determined, one of these points is selected such that it satisfies the requirement that the position of the fourth one of the devices is above the x-y plane.

The radius of each of the spheres can be defined using the following:

$${r}_{j 1}^{2} = {x}^{2} + {y}^{2} + {z}^{2} = {d}^{2}$$

$${r}_{j 2}^{2} = {( x - {b}_{1} )}^{2} + {y}^{2} + {z}^{2} = {e}_{1}^{2}$$

$${r}_{j 3}^{2} = {( x - {a}_{1} \cdot cos {γ}_{1} )}^{2} + {( y - {a}_{1} \cdot sin {γ}_{1} )}^{2} + {z}^{2} = {f}_{1}^{2}$$

which can be solved by an algorithm on the server 2 to obtain the x, y and z coordinates (x₄,y₄,z₄) of the fourth one of the devices, j₄, as

$$x = \frac{{d}_{1}^{2} - {e}_{1}^{2} + {b}_{1}^{2}}{2 {b}_{1}}$$

$$y = \frac{{d}_{1}^{2} - {f}_{1}^{2} + {a}_{1}^{2} - 2 {a}_{1} x \cdot cos {γ}_{1}}{2 {a}_{1} \cdot sin {γ}_{1}}$$

$$z = \sqrt{{d}_{1}^{2} - {x}^{2} - {y}^{2}}$$

Having defined the positions of the devices j₁-j₄ in a local coordinate system, the position of the mobile device i is then computed in this local coordinate system. This is achieved using a further sphere-based trilateration process. Specifically, a series of sphere-based trilateration operations are performed, each of which uses a different group of three of the four tetrahedron vertices as its basis. This process provides four different approximations of the position qᵢ of the mobile device i, from which the average may be taken to more accurately determine the mobile device position.

Once the positions qⱼ₁₋₄ of the four devices j₁-j₄ and the position qᵢ of the mobile device i have been estimated, vertex analysis can be performed to find the relationship between the device positions, mapping the position of the mobile device i back to the positions of the other devices j₁-j₄. The position qᵢ of the mobile device i is therefore determined in the form of a linear weighted sum of the positions q₁₋₄ of the devices j₁₋₄ in step 909. This is achieved by setting up the following equation:

$${q}_{i} = {q}_{j 1} + b ( {q}_{j 2} - {q}_{j 1} ) + c ( {q}_{j 3} - {q}_{j 1} ) + d ( {q}_{j 4} - {q}_{j 1} )$$

This three dimensional linear equation can be solved to determine the coefficients b, c and d. A fourth coefficient can be calculated as:

$$a = 1 - ( b + c + d )$$

to provide a weighted connection between the point qᵢ and the points qⱼ₁-qⱼ₄, where wᵢ₁=a, wᵢ₂=b, wᵢ₃=c, wᵢ₄=d. The above calculation therefore allows the server 2 to determine the position qᵢ of a mobile device i as a consistent linear combination of the positions qⱼ of the four devices j that form a tetrahedron surrounding it, each weighted by a weighting coefficient wᵢⱼ defined by the coefficients a-d above.

As in the two-dimensional case, the steps 903 to 909 are repeated for each device i of unknown location and set of four devices j, allowing sets of four elements with which to define a matrix W of weighting elements wᵢⱼ to be sequentially determined. With sufficient repletion of the tetrahedron analysis method, a system of linear equations can be generated, in which the position qᵢ of each device i in the system is expressed as a consistent linear combination of the positions qⱼ of devices j that surround it, each weighted by a coefficient wᵢⱼ.

As in the two-dimensional case, this system of linear equations can be filtered, by setting some coefficients to zero or otherwise attenuating them, to increase its sparsity. This could be done by adapting any or all of the methods described above in the 2D embodiments, such as imposing a maximum number of tetrahedra to be used for determining the coefficients for each device i, such as four tetrahedra, or a minimum number of non-zero matrix elements (coefficients wᵢⱼ), such as a minimum of four, or a maximum number of non-zero matrix elements, such as a maximum of six, that are allowed in each row.

While in the two-dimensional case described above it is convenient to express 2D positions as complex numbers, this is not as convenient in the three-dimensional case. Instead, each dimension is treated separately, resulting in three different matrix equations representing the x, y and z dimensions respectively. This is possible as the method described above uses only linear equations, such that three separate matrix equations W·x=0, W·y=0 and W·z=0, can be defined in step 911. The form of each of these matrix equations is similar to that described above in relation to the 2D case.

For example, in a system comprising N mobile devices, the matrix equation of device positions in the x-dimension may be represented as

$$W \cdot x = 0 ⇔ [ \begin{matrix}{w}_{11} & … & {w}_{1 N} \\ ⋮ & ⋱ & ⋮ \\ {w}_{N 1} & … & {w}_{NN}\end{matrix} ] \cdot [ \begin{matrix}{x}_{1} \\ ⋮ \\ {x}_{N}\end{matrix} ] = [ \begin{matrix}0 \\ ⋮ \\ 0\end{matrix} ]$$

If it is assumed, as in the two-dimensional case, that there are N devices of unknown position and K devices of known position (e.g. static beacons and/or mobile devices having known positions), the matrix equation above can be split and decomposed as described in relation to the 2D case in step 913, into an inhomogeneous matrix equation to obtain W_{1:N,1:N}·x_{1:N}=bₓ where bₓ is a constant vector.

This process can be applied in the same way for the y- and z-dimensions, in order to obtain the following three inhomogeneous matrix equations for the positions of unknown devices, 1 through N, in a system with K devices of known position.

$${W}_{1 : N , 1 : N} \cdot {x}_{1 : N} = {b}_{x} = ( - 1 ) \cdot [ \begin{matrix}{\sum }_{k = 1}^{K} {w}_{1 , N + k} \cdot {x}_{N + k} \\ ⋮ \\ {\sum }_{k = 1}^{K} {w}_{N , N + k} \cdot {x}_{N + k}\end{matrix} ]$$

$${W}_{1 : N , 1 : N} \cdot {y}_{1 : N} = {b}_{y} = ( - 1 ) \cdot [ \begin{matrix}{\sum }_{k = 1}^{K} {w}_{1 , N + k} \cdot {y}_{N + k} \\ ⋮ \\ {\sum }_{k = 1}^{K} {w}_{N , N + k} \cdot {y}_{N + k}\end{matrix} ]$$

$${W}_{1 : N , 1 : N} \cdot {z}_{1 : N} = {b}_{x} = ( - 1 ) \cdot [ \begin{matrix}{\sum }_{k = 1}^{K} {w}_{1 , N + k} \cdot {z}_{N + k} \\ ⋮ \\ {\sum }_{k = 1}^{K} {w}_{N , N + k} \cdot {z}_{N + k}\end{matrix} ]$$

Solving these three matrix equations for x_{1:N}, y_{1:N} and z_{1:N} provides the positions of the unknown devices. Thus, in step 915, the server 2 solves the system of linear equations, e.g. by inverting the matrix W_{1:N,1:N} or by any other applicable method, to determine a vector containing the positions of the mobile devices 3 of previously unknown position in three dimensions. As in the two-dimensional case, this operation advantageously only has to be carried out once in order to determine the positions of all of the devices of the system having unknown position.

It will be appreciated by those skilled in the art that the invention has been illustrated by describing one or more specific embodiments thereof, but is not limited to these embodiments; many variations and modifications are possible, within the scope of the accompanying claims.

1. A location system comprising a processing system and a memory, wherein the memory stores software comprising instructions which, when executed by the processing system, cause the processing system to perform a method of determining a respective location of each of a plurality of mobile devices of a network of devices, the method comprising:
receiving data comprising a set of values representative of distances between respective pairs of devices of the network of devices, determined from wireless signals transmitted between the devices;
processing the values representative of distances to determine a set of coefficients for a system of linear equations; and
solving the system of linear equations to determine two-dimensional or three-dimensional coordinates representative of the location of each of the plurality of mobile devices in a two-dimensional plane or a three-dimensional space.

2. The location system of claim 1, wherein the wireless signals comprise radio signals or ultrasound signals.

3. The location system of claim 1, wherein the data comprising a set of values representative of distances between respective pairs of devices of the network is determined based on one of more of received signal strength, angle-of-arrival measurements, round-trip-time measurements, time-of-arrival measurements, or time-difference-of-arrival measurements, of the wireless signals transmitted between the devices.

4. The location system of claim 1, wherein each of the coefficients is a respective linear combination of one or more of the values of the set of values.

5. The location system of claim 1, wherein the network of devices comprises one or more devices of known location, the method comprising using a respective two-dimensional or three-dimensional coordinate of one or more devices of known location for determining the two-dimensional or three-dimensional coordinates representative of the respective location of each of the plurality of mobile devices.

6. The location system of claim 1, wherein the two-dimensional plane or three-dimensional space corresponds to a physical environment, and wherein the method comprises using the two-dimensional or three-dimensional coordinates to determine a respective two-dimensional or three-dimensional position of each of the plurality of mobile devices in the physical environment.

7. (canceled)

8. The location system of claim 1, wherein the method comprises storing the set of coefficients as data representing a square matrix comprising a row and a column for each device of the network, wherein solving the system of linear equations comprises calculating an inverse matrix, and wherein the two-dimensional coordinates are determined from the product of the inverse matrix and a vector.

9. (canceled)

10. The location system of claim 1, wherein the method further comprises attenuating one or more coefficients that do not meet an inclusion condition.

11. The location system of claim 1, wherein the method comprises solving the system of linear equations to determine two-dimensional coordinates representative of the location of each of the plurality of mobile devices in a two-dimensional plane, and wherein the two-dimensional coordinates for each of the set of one or more devices are represented in the system of linear equations by complex values or variables.

12. (canceled)

13. The location system of claim 11, wherein determining the set of coefficients comprises identifying, for a device of the network, one or more sets of three further devices of the network that have locations that form a triangle surrounding a location of said device in the two-dimensional plane; and wherein the method further comprises determining the set of coefficients at least in part based on distances between said device and the three further devices, determined from the set of values representative of distances.

14. (canceled)

15. The location system of claim 13, wherein determining the set of coefficients comprises determining a local coordinate system for said device and determining coefficients that represent the locations of the three further devices in said local coordinate system.

16. (canceled)

17. The location system of claim 13, wherein determining the set of coefficients comprises excluding, from the system of linear equations, distances between said device and any further device that is not part of a set of three devices that satisfies a geometric filter for said device, wherein the geometric filter only passes sets of three further devices that form a triangle that surrounds the device or that is within a threshold distance of the device.

18. The location system of claim 13, wherein one or more coefficients of the set of coefficients is weighted based on a variance determined from an analysis of the respective triangles formed by the one or more sets of three further devices.

19. (canceled)

20. The location system of claim 1, wherein the method comprises solving the system of linear equations to determine three-dimensional coordinates representative of the location of each of the plurality of mobile devices in a three-dimensional space.

21. The location system of claim 20, wherein determining the set of coefficients comprises identifying, for a device of the network, one or more sets of four further devices of the network that have locations that form a tetrahedron surrounding a location of said device in the three-dimensional space, and wherein the method further comprises determining the set of coefficients at least in part based on distances between said device and the four further devices, determined from the set of values representative of distances.

22. (canceled)

23. The location system of claim 21, wherein determining the set of coefficients comprises determining a local coordinate system for said device and determining coefficients that represent the locations of the four further devices in said local coordinate system.

24. (canceled)

25. The location system of claim 21, wherein determining the set of coefficients comprises excluding, from the system of linear equations, distances between said device and any further device that is not part of a set of four devices that satisfies a geometric filter for said device, wherein the geometric filter only passes sets of four further devices that form a tetrahedron that surrounds or is within a threshold distance of the device.

26. The location system of claim 21, wherein one or more coefficients of the set of coefficients is weighted based on a variance determined from an analysis of the respective tetrahedra formed by the one or more sets of four further devices.

27. (canceled)

28. (canceled)

29. (canceled)

30. (canceled)

31. (canceled)

32. A method of determining a respective location of each of a plurality of mobile devices of a network of devices, the method comprising:
receiving data comprising a set of values representative of distances between respective pairs of devices of the network of devices, determined from wireless signals transmitted between the devices;
processing the values representative of distances to determine a set of coefficients for a system of linear equations; and
solving the system of linear equations to determine two-dimensional or three-dimensional coordinates representative of the location of each of the plurality of mobile devices in a two-dimensional plane or a three-dimensional space.

33. A non-transitory computer-readable storage medium storing computer software comprising instructions which, when executed by a processing system, cause the processing system to perform a method of determining a respective location of each of a plurality of mobile devices of a network of devices, the method comprising:
receiving data comprising a set of values representative of distances between respective pairs of devices of the network of devices, determined from wireless signals transmitted between the devices;
processing the values representative of distances to determine a set of coefficients for a system of linear equations; and
solving the system of linear equations to determine two-dimensional or three-dimensional coordinates representative of the location of each of the plurality of mobile devices in a two-dimensional plane or a three-dimensional space.
